(19) United States
(12) Patent Application Publication
(10) Pub. No.: US 2021/0260499 A1
(43) Pub. Date: Aug. 26, 2021

(54) DEVICE AND METHOD FOR SEPARATING TWO IMMISCIBLE LIQUIDS BY MEANS OF A BICONTINUOUS PHASE

(71) Applicant: IFP Energies nouvelles, Rueil-Malmaison (FR)

(72) Inventors: Elie AYOUB, RUEIL-MALMAISON CEDEX (FR); Didier FROT, RUEIL-MALMAISON CEDEX (FR)

(21) Appl. No.: 17/185,669

(22) Filed: Feb. 25, 2021

(30) Foreign Application Priority Data
Feb. 26, 2020 (FR) 20/01.858

(51) Int. Cl. B01D 17/04; B01D 17/12; B01D 17/02

(52) U.S. Cl. CPC B01D 17/047; B01D 17/0214; B01D 17/12

(57) ABSTRACT

The invention relates to a device and to a method for separating two immiscible fluids (2, 3), wherein a three-phase system is formed with a Winsor III type bicontinuous phase (4) so as to phagocytize the dispersed droplets and to produce a droplet-free liquid (2).

### FIELD OF THE INVENTION

The present invention relates to the field of separation of two immiscible liquids. More particularly, the present invention relates to the separation of the dispersed drops of a liquid present in another liquid, notably for treatment of an organic or aqueous effluent.

In various liquid-liquid physico-chemical methods in the presence of an emulsion of dispersed droplets or of a microemulsion, it is important to separate the phases so as to be able to exploit the two “clean” liquids.

An example of such a method is the treatment of water from enhanced oil recovery operations. Until recently, the development of a so-called conventional oil field was commonly carried out in two steps: a first primary recovery step based only on the overpressure prevailing within the reservoir, followed by a second step generally using the waterflooding technique. This technique consists in injecting water into the underground formation so as to compensate for the pressure drop within the reservoir, and thus to remobilize the oil in place. This water, as well as the water that may be initially contained in the underground formation, is found in petroleum effluents. It is therefore necessary to treat these petroleum effluents so as to recover only the hydrocarbons. The first step of treating the petroleum effluents generally consists in separating the water and the oil with gravity (using a free water knockout technique for example). The oil thus recovered is sent to desalting and dehydration processes. Furthermore, the water separated from the oil is not completely clean (the gravity separation process is not perfect): it notably contains oil drops and impurities. To remove these impurities and the oil drops, the water is sent to water treatment processes, notably deoiling processes. After the water treatment processes, the quality of the water must be sufficient to meet legal standards or suitable for reinjection into the underground formation.

Currently, the oil industry seeks to optimize hydrocarbon recovery. This can be done by decreasing the residual oil saturation obtained after the waterflooding process, which is 65% on average for preferentially water-wet reservoirs. To meet this goal, new methods, referred to as tertiary oil recovery by chemical flooding (or Chemical Enhanced Oil Recovery cEOR), are being developed. These methods are based on the addition of additives to the sweep water injected, such as polymers, surfactants, alkaline chemicals or a combination of these additives. Now, after breakthrough of this solution into the production well, it has been shown that the properties of the effluent produced at the wellhead are modified by the additives (polymers, surfactants and/or alkaline chemicals), thus making separation methods less effective, notably due to the drop size.

### BACKGROUND OF THE INVENTION

Separating two immiscible liquids can notably be done using the coalescence phenomenon under the effect of gravity or of an augmented gravity, for example in the case of rotary separators such as hydrocyclones, as described notably in patent applications WO-2017/123,095 and US-2014/0,124,437.

Coalescence is the process by which two identical but dispersed substances (notably two liquids) tend to merge. FIG. 1 schematically illustrates the coalescence phenomenon in the case of a drop 7 present in a liquid L1, drop 7 being of the same nature as the liquid L2. At first (left-hand figure), drop 7, subjected to a force, moves towards the interface corresponding to its physical nature; it is the creaming or sedimentation process. Drop 7 is subjected to a force F whose value is [symbol] , with g gravity, v the volume of drop 7 and Δp the density difference between dispersed drop 7 and continuous phase L1. Then (second figure from the left), the hydrodynamics to be considered has changed and liquid film L1 in which drop 7 moves needs to be drained. Finally (third figure from the left), rupture of liquid film L1 occurs and drop 7 empties into a continuous phase of same nature, liquid L2 here. A perturbed interface thus forms (third figure from the left). Then, after a while (right-hand figure), the interface returns to equilibrium and defines a plane. This coalescence phenomenon is valid for rather large drops (of diameter greater than or equal to 1 μm).

For smaller drops, creaming no longer takes place because the drop moves away faster from any point in space, under the effect of the Brownian diffusion, than it moves towards the phase of same nature. In the rest of the description, droplets are understood to be drops with a diameter less than or equal to 100 nm and microemulsion drops. Furthermore, the energy required for the liquid film rupture is greater. FIG. 2 illustrates this phenomenon: a droplet 7 of same nature as liquid L2, which is subjected to a motion M of Brownian diffusion type, will not integrate into liquid L2 because, although it gets closer to the interface, it does not stay long enough to drain the liquid film that separates it from the continuous phase in which it might coalesce. The right-hand figure illustrates the final situation where droplet 7 remains separate from liquid L2.

The coalescence phenomenon can therefore not be implemented for droplets. It is thus necessary to use other physico-chemical phenomena to separate droplets. Besides, implementing the gravity phenomenon is complex and expensive.

### SUMMARY OF THE INVENTION

The objective of the present invention is to provide separation of dispersed droplets (drops with diameter less than or equal to 100 nm and microemulsion drops) of a liquid present in another liquid, the two liquids being immiscible. The invention therefore relates to a device and to a method for separating two immiscible fluids, for which a three-phase system is formed with a Winsor III type bicontinuous phase, so as to phagocytize the dispersed droplets and to produce a droplet-free liquid.

The invention relates to a device for separating two immiscible liquids, referred to as first liquid and second liquid, said device comprising a container containing said first and second liquids, means for injecting a fluid made up of said first liquid and comprising drops of said second liquid, and means for withdrawing said first liquid free of drops of said second liquid. Said container comprises a three-phase system, said three-phase system comprising said first liquid, said second liquid and a Winsor III type bicontinuous phase formed using a surfactant formulation, so as to phagocytize said dispersed drops of said second liquid present in said first liquid.

According to an embodiment, said separation device comprises means for optical measurement of at least said first liquid within said container.

Preferably, said optical measurement means provide measurement of the light intensity scattered in said container.

According to an implementation, said means for injecting said fluid made up of said first liquid and said drops of said second liquid, and said means for withdrawing said first liquid comprise valves.

Advantageously, said separation device comprises means for controlling said valves.

According to an aspect, said first liquid is an aqueous phase and said second liquid is an organic phase.

Furthermore, the invention relates to a method for separating two immiscible liquids referred to as first liquid and second liquid, wherein the following steps are carried out:

a) forming a three-phase system in a container, said three-phase system comprising said first liquid, said second liquid and a Winsor III type bicontinuous phase formed using a surfactant formulation,

b) injecting into the container a fluid made up of said first liquid and comprising drops of said second liquid,

c) phagocytizing said drops of said second liquid in said bicontinuous phase, and

d) withdrawing from said container said first liquid free of drops of said second liquid.

Advantageously, said method comprises a step of optical measurement of at least said first liquid within said container, notably an optical measurement of the light intensity scattered in said container.

According to a variant, said first liquid is withdrawn when said optical measurement detects no drop of the second liquid in said first liquid.

Alternatively, said first liquid is withdrawn after a predetermined time following the injection step.

According to an embodiment, injection of said fluid made up of said first liquid and comprising drops of said second liquid into said container and/or withdrawal of said first liquid free of drops of the second liquid from said container is controlled automatically.

According to a feature, said separation method comprises a step of injecting into said container a surfactant formulation that minimizes the interfacial tension between said first liquid and said second liquid.

Advantageously, said first liquid is an aqueous phase and said second liquid is an organic phase.

Furthermore, the invention relates to the use of the separation device according to one of the above features and/or of the separation method according to one of the above features in a petroleum effluent treatment method, said petroleum effluent being preferably obtained by enhanced oil recovery.

### BRIEF DESCRIPTION OF THE FIGURES

Other features and advantages of the method according to the invention will be clear from reading the description hereafter of embodiments given by way of non-limitative example, with reference to the accompanying figures wherein:

FIG. 1, already described, illustrates the steps of the coalescence phenomenon,

FIG. 2, already described, illustrates the Brownian diffusion type motion of a drop in the first liquid close to a liquid-liquid interface,

FIG. 3 illustrates the evolution of the phases in the container when the physico-chemical parameter is varied,

FIG. 4 illustrates the Brownian diffusion type motion of a drop in the first liquid close to a liquid-Winsor III type bicontinous phase interface,

FIG. 5 illustrates the separation device according to an embodiment of the invention, for three distinct times,

FIG. 6 illustrates the optical measurement means of the device according to an embodiment of the invention, for an example where the first liquid comprises dispersed drops of the second liquid, and

FIG. 7 illustrates the optical measurement means of the device according to an embodiment of the invention, for an example where the first liquid comprises no dispersed drop of the second liquid.

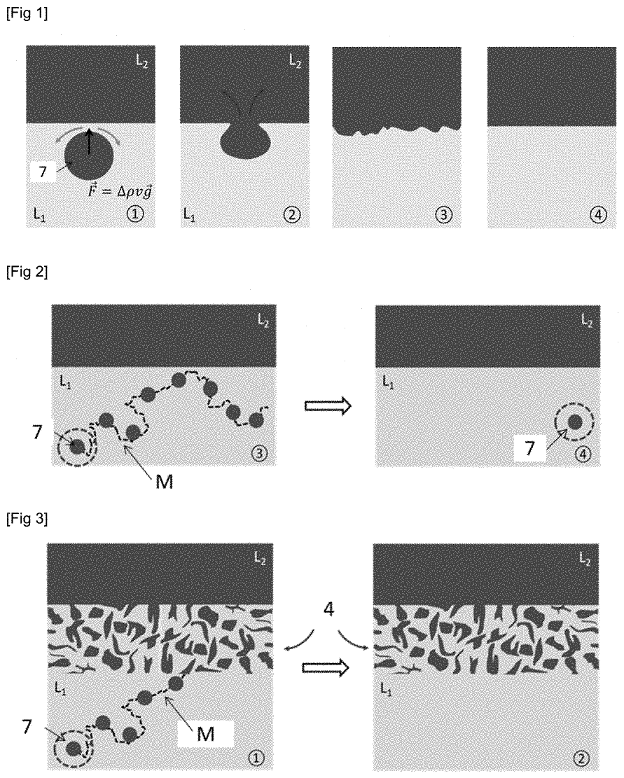

### DETAILED DESCRIPTION OF THE INVENTION

The present invention relates to a device and to a method for separating two immiscible liquids (referred to as first and second liquid), one of the two liquids initially comprising drops dispersed in the other liquid, notably as microdrops or microemulsions. The device and the method according to the invention exploit the phenomenon of phagocytizing the drops dispersed in a Winsor III type bicontinuous phase. This bicontinuous phase is prepared by means of an optimized surfactant formulation whose purpose is to minimize the interfacial tension between the two liquids. The surfactant formulation is therefore predetermined according to the two liquids, in particular, an optimized physico-chemical parameter of the surfactant formulation providing this interfacial tension minimization can be predetermined. The physico-chemical parameter is a parameter of the surfactant formulation that can be varied, and which has an influence on the interfacial tension between the two liquids. By way of non-limitative example, the physico-chemical parameter may be the salinity (NaCl salinity for example), the temperature, the pressure, the use of a cosolvent (alcohol for example), etc.

Preferably, the first liquid can be an aqueous phase and the second liquid can be an organic phase, i.e. oil, for example oil resulting from the development of an underground formation. This implementation is particularly suitable for phase separation of a petroleum effluent, in particular a petroleum effluent obtained by enhanced oil recovery (EOR).

Alternatively, the two liquids can be of any type. For example, the first liquid can be an organic phase and the second liquid can be an aqueous phase. This implementation is particularly suitable for decreasing the presence of water in oil, for decreasing the salinity thereof (organic phase desalting) and notably for limiting hydrate formation risks.

FIG. 3 schematically illustrates various states of two immiscible liquids in the presence of a surfactant formulation, by varying a physico-chemical parameter of the surfactant formulation (the variation of parameter P represented by the horizontal arrow is strictly increasing or decreasing). This figure shows five containers 1, test tubes for example, in which two liquids are represented, first liquid 2 and second liquid 3 respectively. The surfactant formulation is also injected into these containers 1.

For first container 1 (from the left), with a first value of physico-chemical parameter P, dispersed drops 5 of the second liquid are observed in first liquid 2. It is a Winsor I W1 type microemulsion.

For the second container (from the left), with a second value of physico-chemical parameter P, dispersed drops 5 of the second liquid are still observed in first liquid 2, but in a lesser amount, as well as the formation of a new phase 4. It is a bicontinuous phase (comprising both the first liquid and the second liquid). This bicontinuous phase is of Winsor III W3 type. The Winsor III type designates a three-phase system wherein a surfactant-rich intermediate phase forms between the two liquids. This microemulsion is made up of entangled sheets of first and second liquid, without micelles or a predominant continuous phase.

For the third container (from the left), with a third value of physico-chemical parameter P, no dispersed drop of second liquid is observed in first liquid 2, and an increase in volume of bicontinuous phase 4 of Winsor III W3 type is noted.

For the fourth container (from the left), with a fourth value of physico-chemical parameter P, no dispersed drop of second liquid is observed in first liquid 2, and a reduction of the Winsor III W3 type bicontinuous phase is noted. On the other hand, the formation of dispersed drops 6 of the first liquid is observed in second liquid 3.

For the fifth container (from the left), with a fifth value of physico-chemical parameter P, no dispersed drop of second liquid is observed in first liquid 2, the disappearance of the Winsor III type bicontinuous phase and an increase in the number of dispersed drops 6 of the first liquid is noted in second liquid 3. It is a Winsor II W2 type microemulsion.

Thus, varying physico-chemical parameter P provides a transition from a Winsor I emulsion to a Winsor II emulsion, through the appearance and the disappearance of a Winsor III type bicontinuous phase. The optimal physico-chemical parameter (in terms of minimization of the interfacial tension between the two liquids) is parameter P* (central container), it corresponds to the case where no drop is present in the first liquid and no drop is present in the second liquid. It is this surfactant formulation with parameter P* that is used in the device and the method according to the invention. The following documents describe the formation of such a bicontinuous phase:
Jean-Louis SALAGER, Raquel ANTÓN, José Maria ANDÉREZ, Jean-Marie AUBRY, Formulation des microémulsions par la méthode du HLD, Techniques de l'Ingénieur, 2001, Vol. Génie des Procédés J2, Chapter 157, 1-20;
Fukumoto, Ayako, Dalmazzone, Christine, Frot, Didier, Barré, Loic, Noik, Christine, Investigation on Physical Properties and Morphologies of Microemulsions formed with Sodium Dodecyl Benzenesulfonate, Isobutanol, Brine, and Decane, Using Several Experimental Techniques, Energy & Fuels 2016 v. 30 no. 6 pp. 4690-4698.

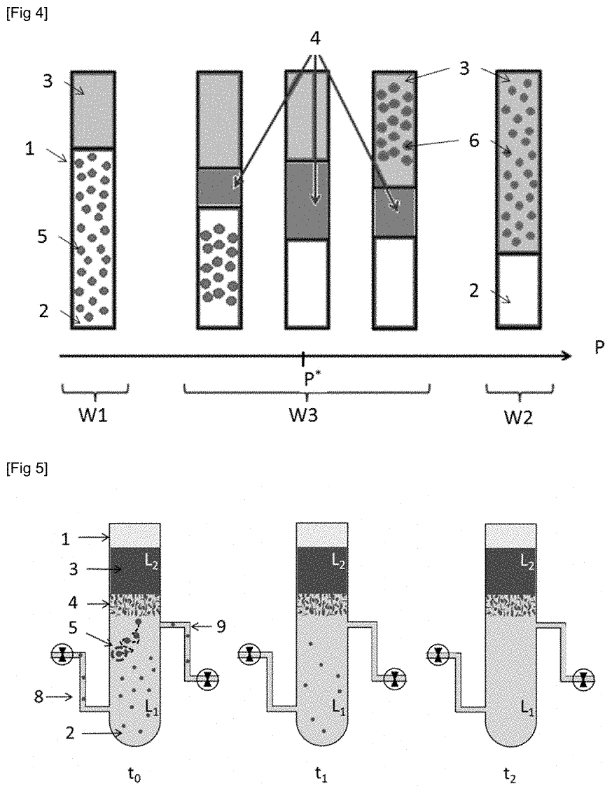

Phagocytizing relates to the collection, by the bicontinuous phase, of the droplets present in the first liquid. Since the bicontinuous phase comprises the two liquids, the droplet, subjected to a Brownian diffusion motion, comes close to the bicontinuous phase and it is collected by the bicontinous phase (there is no liquid film to be traversed). FIG. 4 illustrates this phenomenon, where a droplet 7 of same nature as liquid L2 is subjected to a Brownian diffusion type motion M. Given that a bicontinuous phase 4 has formed between liquid L1 and liquid L2, the phagocytizing phenomenon takes place. Thus, in the final situation (right-hand figure), droplet 7 is included in bicontinuous phase 4. It is this phenomenon that is implemented in the device and the method according to the invention.

The separation device according to the invention comprises:
a container comprising the first and the second liquid, and a surfactant formulation, so as to form a three-phase system containing the first liquid, the second liquid and a Winsor III type bicontinuous phase,
means for injecting a fluid made up of the first liquid and comprising dispersed drops of the second liquid, the injection means being intended to add the fluid comprising the first liquid with dispersed drops of the second liquid into the container, and the injection means may have an injection line, and
means for withdrawing the first liquid free of drops of the second liquid from the container, and the withdrawal means may include a withdrawal line.

The phagocytizing phenomenon in the bicontinuous phase occurs within the container, and the dispersed drops of the second liquid are thus trapped in the bicontinuous phase, which allows a first liquid free of drops of the second liquid to be obtained. Preferably, the device may comprise no second liquid injection means and no surfactant formulation injection means, when the three-phase system is formed, only the phase of the first liquid varies within the container during use.

Preferably, in order to promote drop phagocytizing, the second liquid can be of the same nature as the drops present in the injected fluid.

Advantageously, the means for injecting the fluid made up of the first liquid and comprising drops of the second liquid can be arranged in the lower part of the container (in the operating position thereof) so as to inject the first liquid into the phase of the first liquid already present in the container.

Advantageously, the means for withdrawing the first liquid can be arranged in the lower part of the container (in the operating position thereof) so as to withdraw only the first liquid in the phase of the first liquid present in the container.

The container can have any form. According to an example embodiment, it can have the form of a column of circular section, rectangular section, etc.

According to an embodiment of the invention, the separation device can comprise means enabling optical measurement of at least the first liquid within the container. The optical measurement means allow to determine the presence of dispersed drops in the first liquid and thus to perform withdrawal of the first liquid free of drops of the second liquid.

Furthermore, the device can comprise second means enabling optical measurement of the second liquid within the container so as to determine the presence of dispersed drops of the first liquid within the second liquid. The optical measurement means may be identical for both measurements.

According to an implementation of the invention, optical measurement can be performed by analysing the light intensity scattered by the first liquid (respectively the second liquid) in the container. Indeed, the scattered light intensity varies considerably with the presence or the absence of drops in the first liquid (respectively in the second liquid), in particular when the first liquid is an aqueous phase.

According to an optional embodiment of this implementation, the LS (Light Scattering) method can be used. This LS method provides detection of dispersed droplets. Alternatively, other methods may be applied, such as absorbed or transmitted light intensity measurement.

Preferably, the container can be transparent for performing the optical measurements, it can be made of glass or quartz for example.

To control injection of the first liquid into the container, the means for injecting the first liquid can comprise at least one valve.

To control withdrawal of the first liquid from the container, the withdrawal means can comprise at least one valve.

In cases where the injection means and the withdrawal means comprise at least one valve, the device according to the invention can comprise valve control means. Thus, injection and withdrawal of the first liquid can be achieved automatically. The control means may be computer means, such as a computer.

For this embodiment (with valve control means), and when the device comprises means for optical measurement of the first liquid within the container, the control means can be capable of automatically carrying out the following steps:
open the valve of the withdrawal means when no drop of the second liquid is detected by the optical measurement means in the first liquid in order to withdraw the first liquid free of drops of the second liquid, the valve of the injection means being closed, then
close the valve of the withdrawal means when withdrawal is completed, then
open the valve of the injection means to inject a fluid comprising the first liquid and dispersed drops of the second liquid into the container, the valve of the withdrawal means remaining closed, then
close the valve of the injection means when the amount of first liquid in the container is sufficient, the valve of the withdrawal means remaining closed.

When both valves are closed, the phagocytizing phenomenon is implemented and the control means perform no action until the optical means do not detect any more drop in the first liquid.

In a variant, instead of controlling the valves according to the optical detection of the drops, the control means can control the valves (according to the valve opening and closing sequence described above for example) after a predetermined phagocytizing time.

According to an implementation of the invention, the device can comprise a transparent liquid bath (according to a non-limitative example, the liquid bath may comprise water) in which the container can be immersed, and the temperature of the bath can be controlled by liquid bath temperature control means. It is thus possible to adjust (thermostatically control) the temperature of the container content. This provides a simple means of minimizing temperature gradients in the container (better temperature homogenization in the container). Besides, for the embodiment where the container is made of glass, the glass-liquid interface has the advantage of minimizing the refractive index difference, and therefore of reducing parasitic scattering and reflections (notably in the case of used containers), which promotes optical measurement and therefore detection of the presence or not of drops. Furthermore, this embodiment allows to use containers of non-maximum optical quality grade, which allows costs to be reduced.

FIG. 5 schematically illustrates, by way of non-limitative example, the separation device according to an embodiment of the invention. This figure shows the device at three different times: t₀ (left-hand figure) during injection of the fluid containing the first liquid and dispersed drops of the second liquid, t₁ (central figure) during the phagocytizing phenomenon and t₂ (right-hand figure) during withdrawal of the first liquid free of drops of the second liquid.

The separation device comprises a container 1 in which two liquids are shown, first liquid 2 and second liquid 3 respectively. The surfactant formulation is also injected into containers 1 so as to form a Winsor III type bicontinuous phase 4. The separation device also comprises a fluid injection line 8 and a first liquid withdrawal line 9. Lines 8 and 9 are located in the lower part of container 1 in the operating position thereof.

At t₀, a fluid is injected through injection line 8. The fluid comprises first liquid 2 and dispersed drops 5 of the second liquid. Thus, container 1 comprises, in the phase of first liquid 2, dispersed drops 5 of the second liquid.

At t₁, dispersed drops 5 are being phagocytized by bicontinuous phase 4, due to the conditions (presence of surfactant, optimal physico-chemical parameter, etc.) prevailing in container 1. Less drops are observed at the time t₁ than at to.

At t₂, all the drops 5 have been phagocytized by bicontinuous phase 4. First liquid 2 free of drops 5 of the second liquid can then be withdrawn through withdrawal line 9.

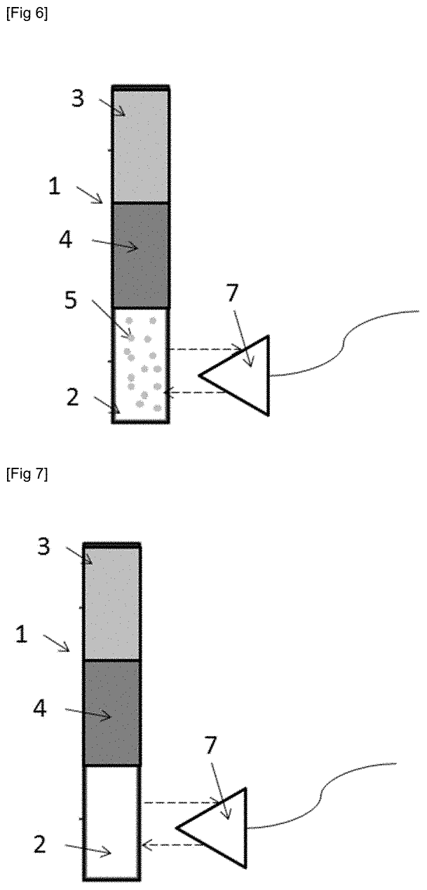

FIGS. 6 and 7 schematically illustrate, by way of non-limitative example, the device according to an embodiment of the invention where the separation device comprises optical measurement means. The device comprises a container 1 and optical measurement means 7. In these figures, optical measurement means 7 are represented as a single element, they may alternatively comprise two distinct elements: a light source and a light detector, which can for example be arranged on either side of container 1. Container 1 comprises three phases: first liquid 2, bicontinuous phase 4 and second liquid 3. Optical measurement means 7 can emit and receive light signals (represented by dotted arrows) towards/from first liquid 2.

FIG. 6 illustrates the use of the device in cases where first liquid 2 contains dispersed drops 5 of the second liquid (this FIG. 6 corresponds to the times t₀ and t₁ of FIG. 5). In this figure, optical measurement means 7 detect drops 5. Therefore, the first liquid is not withdrawn.

FIG. 7 illustrates the use of the device after phagocytizing of the drops, wherein container 1 comprises three phases: first liquid 2, bicontinuous phase 4 and second liquid 3. First liquid 2 and second liquid 3 comprise no drop: all the drops have been phagocytized in bicontinuous phase 4. This FIG. 7 corresponds to the third situation (time t₂) of FIG. 5. In this figure, optical measurement means 7 detect no drop in first liquid 2. Therefore, first liquid 2 free of drops 5 of the second liquid can be withdrawn.

The separation method according to the invention comprises the following steps:
forming a three-phase system in a container, said three-phase system comprising the first liquid, the second liquid and a Winsor III type bicontinuous phase, this Winsor III type bicontinuous phase being obtained by means of a surfactant formulation injected into the container,
injecting into the container a fluid made up of the first liquid and comprising dispersed drops of the second liquid; the container thus comprises the three-phase system for which the first liquid comprises dispersed drops of the second liquid,
phagocytizing the dispersed drops of the second liquid in the bicontinuous phase so as to form a phase of the first liquid free of drops of the second liquid, and
withdrawing the first liquid free of drops of the second liquid.

Preferably, the method may not comprise a step of injecting the second liquid or the surfactant formulation when the three-phase system is formed: during operation, the method comprises a single injection step, which consists in injecting a fluid comprising the first liquid and dispersed drops of the second liquid.

Advantageously, the method according to the invention can use the separation device according to any one of the variants or variant combinations described above.

According to an embodiment, after preparing the container with the surfactant formulation, the systems can be left to equilibrate at constant temperature for a predetermined time period that depends on the liquids considered. Thus, the system is thermodynamically stable prior to phagocytizing.

According to an implementation of the invention, the method can comprise an optical measurement step for measuring at least said first liquid within the container. The optical measurement means allow to determine the presence of dispersed drops in the first liquid, and thus to carry out withdrawal of the liquid free of drops of the second liquid.

According to an embodiment, the method can use second optical measurement means for measuring the second liquid in the container so as to determine the presence of dispersed drops of the first liquid within the second liquid. The optical measurement means may be identical for the two measurements.

According to an implementation of the invention, the optical measurement can be performed by analysing the light intensity scattered by the first liquid (respectively the second liquid) in the container. Indeed, the scattered light intensity varies significantly with the presence of the absence of dispersed drops in the first liquid (respectively the second liquid), in particular when the first liquid is an aqueous phase. According to an optional embodiment of this implementation, the LS (Light Scattering) method can be used. This LS method provides detection of dispersed droplets. Alternatively, other methods may be applied, such as the absorbed or transmitted light intensity measurement.

According to an embodiment, the step of withdrawing the first liquid free of drops of the second liquid can be carried out only when the optical measurement means do not detect any more drop of the second liquid in the first liquid. This allows to ensure that the phagocytizing phenomenon is completed prior to withdrawing the first liquid.

Alternatively, the step of withdrawing the first liquid free of drops of the second liquid can be carried out after a predetermined time period following the end of the step of injecting the fluid comprising the first liquid and dispersed drops of the second liquid. This alternative notably allows to do without optical measurement means, which simplifies the invention.

Advantageously, the injection and/or withdrawal steps can be carried out automatically so as to simplify the method of separating the two immiscible liquids.

According to an embodiment of the invention, the separation method can comprise a prior step of injecting into the container a surfactant formulation that minimizes the interfacial tension between the two liquids.

According to an implementation of the invention, the container can be immersed in a transparent liquid bath (by way of non-limitative example, the liquid bath can comprise water) whose temperature is controlled. It is thus possible to adjust (thermostatically control) the temperature of the container content. Furthermore, it is a simple means of minimizing temperature gradients in the container (better temperature homogenization in the container). Besides, for the embodiment where the container is made of glass, the glass-liquid interface has the advantage of minimizing the refractive index difference, and therefore of reducing parasitic scattering and reflections (notably in the case of used containers), which promotes optical measurement and therefore detection of the presence of drops. This embodiment further allows to use containers of non-maximum optical quality grade, which allows costs to be reduced.

The invention also relates to the use of the separation device and/or method in a petroleum effluent treatment method. A petroleum effluent is understood to be a fluid recovered through a production well with a hydrocarbon recovery method implemented in an underground formation. A petroleum effluent generally comprises oil (hydrocarbons in liquid form), gas (hydrocarbons in gas form) and water, and also at least part of a sweep fluid injected into the formation for recovery of the hydrocarbons.

The petroleum effluent treatment method can comprise at least the following steps:

a) carrying out separation of the petroleum effluent phases, so as to separate at least an aqueous liquid phase, a liquid oil phase and a gas phase; this separation can be a gravity separation, of free water knockout type for example. After this step, the aqueous liquid essentially comprises water, oil drops and at least a surfactant,

b) treating the aqueous liquid resulting from the separation by means of the separation device and/or method according to one of the features described above. The quality of the water is thus improved.

Furthermore, the invention relates to an enhanced oil recovery method implemented in an underground formation. The enhanced oil recovery method comprises at least the following steps:

a) injecting a fluid into the underground formation, through an injection well, the injected fluid comprising at least a surfactant; the injected fluid may also comprise polymers,

b) recovering a petroleum effluent in the underground formation, through a production well, the petroleum effluent comprising at least part of the injected fluid, i.e. part of the surfactant, polymers,

c) carrying out separation of the petroleum effluent phases, so as to separate at least an aqueous liquid phase, a liquid oil phase and a gas phase; this separation can be a gravity separation, of free water knockout type for example. After this step, the aqueous liquid essentially comprises water, oil drops and at least a surfactant, and

d) treating the aqueous phase by means of the device and/or the method as described above. The quality of the water is thus improved.

1. A device for separating two immiscible liquids, referred to as first liquid and second liquid, the device comprising a container containing the first and second liquids, means for injecting a fluid made up of the first liquid and comprising drops of the second liquid, and means for withdrawing the first liquid free of drops of the second liquid, wherein the container comprises a three-phase system, the three-phase system comprising the first liquid, the second liquid and a Winsor III type bicontinuous phase formed using a surfactant formulation, so as to phagocytize the dispersed drops of the second liquid present in the first liquid.

2. A separation device as claimed in claim 1, wherein the separation device comprises means for optical measurement of at least the first liquid within the container.

3. A separation device as claimed in claim 2, wherein the optical measurement means provide measurement of the light intensity scattered in the container.

4. A separation device as claimed in claim 1, wherein the means for injecting the fluid made up of the first liquid and the drops of the second liquid, and the means for withdrawing the first liquid comprise valves.

5. A separation device as claimed in claim 4, wherein the separation device comprises means for controlling the valves.

6. A separation device as claimed in claim 1, wherein the first liquid is an aqueous phase and the second liquid is an organic phase.

7. A method for separating two immiscible liquids referred to as first liquid and second liquid, wherein the following steps are carried out:
a) forming a three-phase system in a container, the three-phase system comprising the first liquid, the second liquid and a Winsor III type bicontinuous phase formed using a surfactant formulation,
b) injecting into the container a fluid made up of the first liquid and comprising drops of the second liquid,
c) phagocytizing the drops of the second liquid in the bicontinuous phase, and
d) withdrawing from the container the first liquid free of drops of the second liquid.

8. A separation method as claimed in claim 7, wherein the method comprises a step of optical measurement of at least the first liquid within the container, notably an optical measurement of the light intensity scattered in the container.

9. A separation method as claimed in claim 8, wherein the first liquid is withdrawn when the optical measurement detects no drop of the second liquid in the first liquid.

10. A separation method as claimed in claim 7, wherein the first liquid is withdrawn after a predetermined time following the injection step.

11. A separation method as claimed in claim 7, wherein injection of the fluid made up of the first liquid and comprising drops of the second liquid into the container and/or withdrawal of the first liquid free of drops of the second liquid from the container is controlled automatically.

12. A separation method as claimed in claim 7, wherein the separation method comprises a step of injecting into the container a surfactant formulation that minimizes the interfacial tension between the first liquid and the second liquid.

13. A separation method as claimed in claim 7, wherein the first liquid is an aqueous phase and the second liquid is an organic phase.

14. Use of the separation device as claimed in claim 1 in a petroleum effluent treatment method, the petroleum effluent being preferably obtained by enhanced oil recovery.

15. A petroleum effluent treatment method, comprising separating two immiscible liquids in a petroleum effluent with the device as claimed in claim 1.

16. A petroleum effluent treatment method, comprising separating two immiscible liquids in a petroleum effluent obtained by enhanced oil recovery with the device as claimed in claim 1.
